(19) United States
(12) Patent Application Publication
(10) Pub. No.: US 2025/0200419 A1
(43) Pub. Date: Jun. 19, 2025

(54) SYSTEMS AND METHODS FOR OPTIMIZING QUANTUM CIRCUIT SIMULATION USING GRAPHICS PROCESSING UNITS

(71) Applicant: University of Pittsburgh - Of the Commonwealth System of Higher Education, Pittsburgh, PA (US)

(72) Inventor: Xulong Tang, Wexford, PA (US)

(21) Appl. No.: 18/847,839

(22) PCT Filed: Mar. 17, 2023
(86) PCT No.: PCT/US2023/015462

§ 371 Date: Sep. 17, 2024

Related U.S. Application Data
(60) Provisional application No. 63/321,168, filed on Mar. 18, 2022.

(51) Int. Cl. G06N 10/80

(52) U.S. Cl. CPC G06N 10/80

(57) ABSTRACT

Efficient simulation of a quantum computer can be achieved by minimizing the time required for data exchange between a host processor and a specialized processor simulating quantum computations. The data exchange time can be minimized using a partitioned memory that facilitates the exchange from the host processor to the specialized processor of the data to be processed simultaneously with the exchange from the specialized processor to the host processor of the data already processed. The data exchange time can also be minimized by identifying data that would not change as a result of a quantum computation, and by not exchanging such data.

### CROSS-REFERENCE TO RELATED APPLICATIONS

This application claims priority to and the benefit of U.S. Provisional Patent Application No. 63/321,168, entitled “SYSTEMS AND METHODS FOR OPTIMIZING QUANTUM CIRCUIT SIMULATION USING GRAPHICS PROCESSING UNITS,” filed on Mar. 18, 2022, the entire contents of which are incorporated herein by reference.

### TECHNICAL FIELD

The following disclosure is directed to methods and systems for optimizing quantum computing simulation and, more specifically, methods and systems for using graphics processing units (GPUs) to optimize quantum computing simulation performance.

### BACKGROUND

In quantum computing systems, individual quantum bits (qubits) are the fundamental units of computation upon which logical operations can be performed. A qubit is a two-level quantum system defined by two orthonormal basis states (|0 [symbol] and |1 [symbol] ), where a quantum state (|ψ [symbol] ) can be expressed any linear combination of the basis states (|ψ [symbol] =a₀|0 [symbol] +a₁|1 [symbol] ), where a₀ and a₁ are complex number whose squares represent the probability amplitudes of basis states |0 [symbol] and |1 [symbol] . States of a quantum computing system can be generally represented by state vectors, where quantum computation corresponds to changes to a quantum computing system's state vectors. For an n-qubit system, there may be 2ⁿ state amplitudes, such that the state of the n-qubit system can be represented by a state vector with 2ⁿ dimensions. A quantum computing system may be configured by (e.g., built upon) a quantum circuit including one or more quantum gates (referred to as “gates”), where a particular quantum algorithm is described and/or defined by the quantum circuit. Quantum gates may be represented by unitary operations that can be applied to qubits to map a first quantum state to a second quantum state.

Recently, quantum computing systems have undergone rapid development, where particular quantum computing systems have been configured to operate with increasing numbers of qubits. However, present quantum computing systems still remain in the Noisy-Intermediate Scale Quantum (NISQ) era, where individuals have limited access to reliable quantum computing systems. Accordingly, quantum circuit simulation (QCS) toolsets have been produced that enable quantum computing algorithm development, evaluation of newly proposed quantum computing circuits, and quantum computer design exploration without the use of quantum computing hardware. But, existing QCS toolsets suffer from a number of deficiencies, including being computationally- and memory-intensive. Some examples of deficiencies of present QCS toolsets include (1) discrepancies in supported quantum gates for different QCS toolsets; (2) increases in simulation (e.g., computation and memory) cost with increased numbers of qubits and complexity of quantum circuits; and (3) a lack of optimizations to make full use of computing resources (e.g., GPUs and/or central processing units (CPUs)). GPUs have previously been utilized to perform QCS in high-performance computing platforms, where when applying a gate to an n-qubit quantum circuit, 2ⁿ state amplitudes (e.g., that correspond to the n-qubit quantum circuit) may be evenly divided into groups, and each group of amplitudes may be updated independently in parallel by GPU threads (referred to as “parallelism”). However, GPU memory limitations reduce the benefits of such parallelism.

Other optimization techniques for QCS computing resources have made use of multi-GPU supported simulation, CPU-based simulation, and CPU-GPU collaborative simulation. But, these optimization techniques fail to make use of GPU parallelization and fail to minimize data movement between computing resources including GPUs and CPUs. As an example, a present GPU-based QCS optimization technique can suffer from low GPU utilization when the number of qubits in a quantum circuit is large. As a result, most state amplitudes are stored and updated on the CPU, failing to take advantage of the GPU parallelization. Moreover, the static and unbalanced allocation of state amplitudes can introduce frequent amplitudes exchange between CPU and GPU, which can further introduce significant data movement and synchronization overheads. Accordingly, there is a need for improved QCS techniques that remedy the deficiencies of present QCS toolsets and provide scalable, efficient QCS for increased numbers of qubits.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

Disclosed herein are systems and methods for using graphics processing units (GPUs) to optimize QCS performance. In one aspect, the disclosure features a method for efficient simulation of a quantum computer. The method can include: identifying from a plurality of state amplitude vector chunks, a first chunk and a second chunk, wherein any state amplitude vector in the second chunk is updatable independently of an update to any state amplitude vector in the first chunk; and simultaneously transferring: (i) from a first memory partition of a vector processor to a host processor an updated first chunk, and (ii) from the host processor to a second memory partition of the vector processor the second chunk.

Various embodiments of the method can include one or more of the following features. The method can include identifying a qubit having a zero probability of being in a quantum state 1. The method can include identifying one or more chunks from the plurality of state amplitude vector chunks corresponding to the identified qubit. The method can include preventing transferring of the identified one or more chunks from the host processor to the vector processor.

In some embodiments, the method can include scheduling application of one or more gates by the vector processor to the first chunk based on an order of involvement of a plurality of qubits. The scheduling can include greedy reordering or forward-looking reordering. The method can include compressing the updated first chunk prior to transferring the updated first chunk from the vector processor to the host processor. The compressing can include segmenting the updated first chunk into a plurality of segments, each segment being assigned to a respective warp in the vector processor. The method can include receiving from the host processor to these first or the second memory partition of the vector processor a compressed chunk. The method can include decompressing the compressed chunk by the vector processor. The method can include processing the decompressed chunk by the vector processor.

Other aspects of the invention comprise systems implemented in various combinations of computing hardware and software to achieve the methods described herein.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from foregoing and following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the generally description given above and the detailed description of the preferred embodiments given below serve to explain and teach the principles described herein.

FIG. 1 shows a diagram of exemplary state vector partitioning and allocation by an exemplary quantum simulator.

FIG. 2 shows a diagram of an exemplary QCS framework for a quantum circuit simulator.

FIG. 3 shows operations of an exemplary pruning algorithm.

FIG. 4 shows operations of an exemplary greedy reordering algorithm.

FIG. 5 shows operations of an exemplary forward-looking reordering algorithm.

FIG. 6 shows a diagram of exemplary reordering of quantum operations.

FIG. 7 shows a diagram of exemplary decompression and compression of state amplitude vectors.

FIG. 8 shows operation of an exemplary QCS framework for a quantum circuit simulator in a multi-graphics processing units (multi-GPU) application.

FIG. 9 shows a diagram of exemplary performance of an exemplary QCS framework for a quantum circuit simulator.

FIG. 10 is a block diagram of an example computer system.

FIG. 11 is a schematic block diagram of a processing system having partitioned memory configured as circular buffers.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Disclosed herein are embodiments of systems and methods for using graphics processing units (GPUs) to optimize QCS performance. In some embodiments, the systems and methods may mitigate data movement overhead and may rely on a plurality of optimizations that enhance the scalability and efficiency of QCS. The systems and methods may execute optimizations involving (1) proactive state amplitude transfer to fully utilize the bi-directional data transfer bandwidth between CPU(s) and GPU(s); before copying state amplitudes to GPU, (2) dynamic redundancy elimination that prunes zero state amplitudes to avoid unnecessary data movements; (3) a compiler-assisted, dependency-aware quantum gate reordering to enlarge the potential of pruning by enlarging the number of zero amplitudes; and (4) a GPU-supported, lossless amplitude compression to reduce the data transfer caused by non-zero state amplitudes with minimal runtime overheads.

The various embodiments of the systems and methods may use GPUs as the main execution engine for QCS. The systems and methods may use one or more end-to-end optimizations to utilize the rich computational parallelism on GPUs and minimize an amount of data movement between CPU and GPU. As a first optimization, instead of statically assigning state amplitudes on GPU and CPU as used in previous QCS techniques, the systems and methods may dynamically allocate groups of state amplitudes on the GPU and may exchange (e.g., proactively exchange) the state amplitudes between CPU and GPU. Doing so can maximize the overlap of data transfer between CPU and GPU, thereby improving the GPU utilization and reducing the GPU idleness. As a second optimization, instead of using a single data compression algorithm to compress all state amplitudes as used in previous QCS techniques, the systems and methods may use zero-valued and non-zero state amplitudes differently and separately. For zero amplitudes, the systems and methods may use reordering algorithms to select (e.g., greedily select) quantum gates that involve the least number of qubits. Such an optimization is based on the observation that the fewer qubits that are associated with quantum gates, the greater number of zero-valued state amplitudes that can be pruned. For non-zero amplitudes, the systems and methods may use efficient lossless data compression on GPU to further reduce data transfer.

### Quantum Circuit Simulation (QCS) Overview

Several approaches and techniques may be used to perform QCS, where each technique includes respective advantages and/or disadvantages. Some examples of QCS techniques include Schrodinger-style simulation, stabilizer formalism simulation, tensor network simulation, and full state vector simulation. In some cases, QCS techniques may involve targeting of one or more quantum circuit benchmarks that may be used to characterize the respective QCS technique. Examples of quantum circuit benchmarks are described in Table 1:

TABLE 1
Quantum Circuit Benchmarks

| Abbreviation | Application |
|---|---|
| hchain | Linear hydrogen atom chain |
| rqc | Random quantum circuit |
| qaoa | Quantum approximate optimization algorithm |
| gs | Graph state |
| hlf | Hidden linear function |
| qft | Quantum Fourier transform |
| iqp | Instantaneous quantum polynomial time |
| qf | Quadratic form |
| bv | Bernstein-Vazirani algorithm |

As described by Table 1, QCS techniques may target a number of quantum circuit benchmarks to evaluate the performance of the respective QCS techniques. An “hchain” circuit may refer to a circuit for a representative quantum chemistry application which describes a system of hydrogen atoms arranged linearly. An hchain circuit may incorporate increased circuit depth and an early entanglement in terms of total operations. An “rqc” circuit may refer to a random quantum circuit that may be used to represent supremacy of quantum computing compared to conventional computers. A “qaoa” circuit may refer to a quantum approximate optimization algorithm circuit that may be a quantum algorithm in the NISQ era that can produce approximate solutions for combinatorial optimization problems. A “gs” circuit may refer to a circuit that may be used to prepare graph states that are multi-particle entangled states. Examples of a “gs” circuit may include many-body spin states of distributed quantum systems that are useful in quantum error correction. An “hlf” circuit may refer to a benchmark circuit that can solve a 2D hidden linear function problem. A “qft” circuit may refer to a quantum Fourier transform circuit that may be a quantum analog of the inverse discrete Fourier transform, which may be applicable in Shor's algorithm. An “iqp” circuit may refer to an instantaneous quantum polynomial circuit that may provide evidence that sampling an output probability distribution of quantum circuit is difficult when using conventional computing techniques. A “qf” circuit may implement a quadratic form on binary variables encoded in qubit registers. A “qf” circuit may be used to solve quadratic unconstrained binary optimization problems. A “by” circuit may implement an algorithm to solve the Bernstein-Vazirani problem. Embodiments of systems and methods for using GPUs to optimize QCS performance may be evaluated based on one or more of quantum circuit benchmarks described herein.

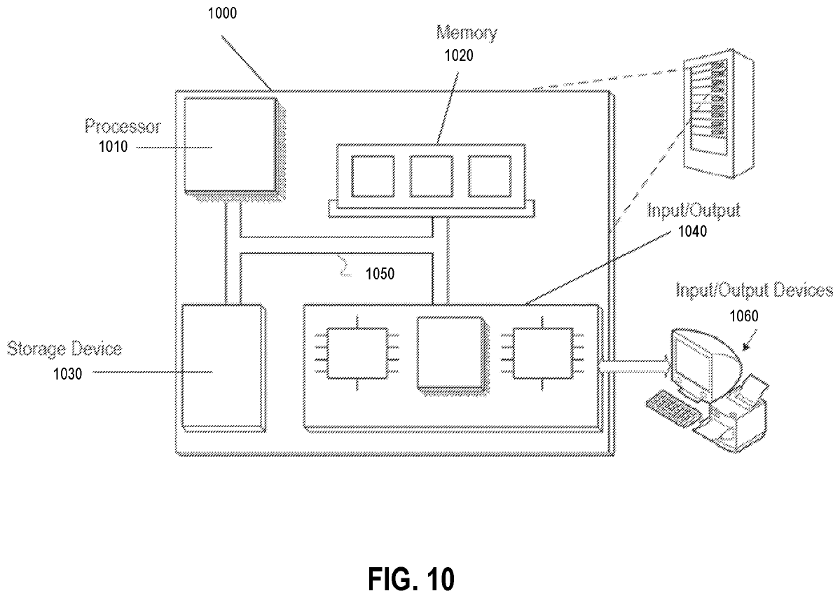

In some embodiments, systems for using GPUs to optimize QCS performance may include a computing device (e.g., server computing device) to operate as a quantum circuit simulator. The computing device may include one or more CPUs, where each CPU includes one or more cores operating at any suitable clock speed. As an example, a computing device may include two CPUs, where each CPU includes ten cores each operating at a clock speed of approximately 2.2 GHz. In some cases, the computing device may include any suitable type and size of memory coupled to the CPU(s). As an example, the computing device may include 384 gigabytes of memory (e.g., dynamic random-access memory (DRAM)). In some cases, the computing device may include at least one GPU coupled to the CPU(s). The GPU may include and/or be coupled to GPU memory. As an example, the GPU may include and/or otherwise be coupled to 16 gigabytes (or any other suitable amount) of GPU memory via a Peripheral Component Interconnect Express (PCIe) connection (or another suitable connection). In some cases, the computing device may be included in a computing system (e.g., computer system 1000) as described with respect to FIG. 10.

### Baseline Quantum Circuit Simulation (QCS)

Conventionally, baseline QCS can involve steps including (1) state vector partitioning; (2) static state amplitude allocation; and (3) on-demand amplitudes exchange, where the baseline (also referred to as “conventional”) quantum circuit simulator simulates quantum computations by iteratively applying gates on and/or to the state vector. Applying gates on and/or to the state vector can include applying one or more vector-matrix multiplications. An example of vector-matrix multiplication is described in Equation 1 with respect to applying a Hadamard (H) quantum gate to a qubit j with n number of qubits.

$$[ \begin{matrix}{{a}^{′}}_{x … x {0}_{j} x ... x} \\ {{a}^{′}}_{x … x {1}_{j} x ... x}\end{matrix} ] = \frac{1}{\sqrt{2}} [ \begin{matrix}1 & 1 \\ 1 & - 1\end{matrix} ] [ \begin{matrix}{a}_{x … x {0}_{j} x ... x} \\ {a}_{x … x {1}_{j} x ... x}\end{matrix} ] \qquad ( 1 )$$

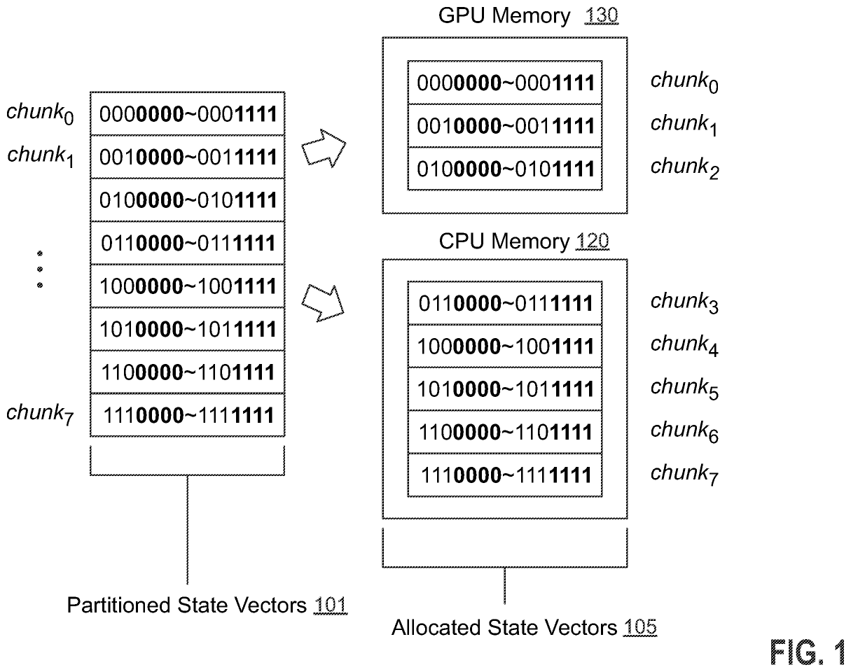

For state vector partitioning as a part of baseline QCS, a baseline quantum simulator may partition state vectors into “chunks”. A chunk may be a granularity used in the baseline quantum simulator to update the state vector. FIG. 1 shows exemplary state vector partitioning and allocation by a baseline quantum simulator. While FIG. 1 shows exemplary state vector partitioning and allocation for a 7-qubit circuit (e.g., corresponding to 2⁷ state amplitudes), a quantum circuit with any suitable number of qubits may be partitioned and allocated as shown in FIG. 1. For a 7-qubit circuit, there can be a total of 2⁷ different state amplitudes ranging from a₀₀₀₀₀₀₀ to a₁₁₁₁₁₁₁. Each of the states may be stored in a vector (referred to as a “state vector”), and the state vector may be partitioned into 8 chunks (e.g., ranging from chunk₀ to chunk₇ as shown in FIG. 1) as shown for the partitioned state vectors 101. The state vector may be partitioned into any suitable number of chunks based on the configured and/or preferred execution performance for QCS. Each chunk may include 16 state amplitudes as shown in FIG. 1. The 3 most significant bits (MSBs) of a chunk may be used to index the respective chunk and the remaining 4 bits may be offsets within the respective chunk.

For static state amplitude allocation as a part of baseline QCS, the baseline quantum simulator may allocate chunks of partitioned state vectors 101 to CPU memory 120 and/or GPU memory 130 as allocated state vectors 105. The chunks of partitioned state vectors 101 may be allocated based on the capacity of the GPU memory 130. As shown in FIG. 1, when the capacity of the GPU memory 130 is 3 chunks, the remaining chunks may be stored on the CPU memory 120. As an example, if 64 gigabytes of memory (e.g., combined CPU memory 120 and GPU memory 130) is required to simulate 32 qubits and the GPU memory 130 has a size of 16 gigabytes, the first 16 gigabytes of the required 64 gigabytes may be allocated to the GPU memory 130 and the remaining 48 gigabytes may be allocated to the CPU memory 120.

For reactive (also referred to as “on-demand”) chunk exchange as a part of baseline QCS, the baseline quantum simulator may perform a chunk exchange between the GPU memory 130 and the CPU memory 120 when the requested state amplitudes are not locally available on the GPU memory 130. In some cases, the chunk exchange between the CPU memory 120 and the GPU memory 130 may be triggered on-demand, such that when both the chunks on the CPU memory 120 and the GPU memory 130 are involved in one state update, the corresponding chunks stored by the CPU memory 120 are transferred to the GPU memory 130 for updating. After the update operation, the updated chunks can be transferred back to the CPU memory 120 from the GPU memory 130. An amount of data transferred between the CPU memory 120 and the GPU memory 130 may be based on (e.g., dependent on) the number of qubits in the specific quantum gate simulation of the QCS. In some cases, each of the indices of the qubits involved in the current quantum gate are smaller than the chunk size. For such cases, each chunk can be independently updated without requiring additional data movement between the CPU memory 120 and the GPU memory 130. In other cases, at least some indices of the qubits involved in the current quantum gate are outside the chunk boundary. For such cases, as shown in FIG. 1, none of the chunks include a pair of the required amplitudes and the computation for updating amplitudes involves more than one chunk, which can require data exchange between the CPU memory 120 and the GPU memory 130. As an example, based on updates to the pair of chunk₁ and chunk₃ in FIG. 1 involving chunks stored on the CPU memory 120 and the GPU memory 130, data may be required to be exchanged between the CPU memory 120 and the GPU memory 130. For the baseline quantum simulator, requested chunks may be copied from CPU memory 120 to GPU memory 130. Accordingly, chunk₃ may be copied by the CPU to the GPU memory 130. Based on (e.g., after) chunk₃ is updated with chunk₁ on the GPU memory 130, the updated version of chunk₃ may be copied back to the CPU memory 120 to replace the previous version of chunk₃.

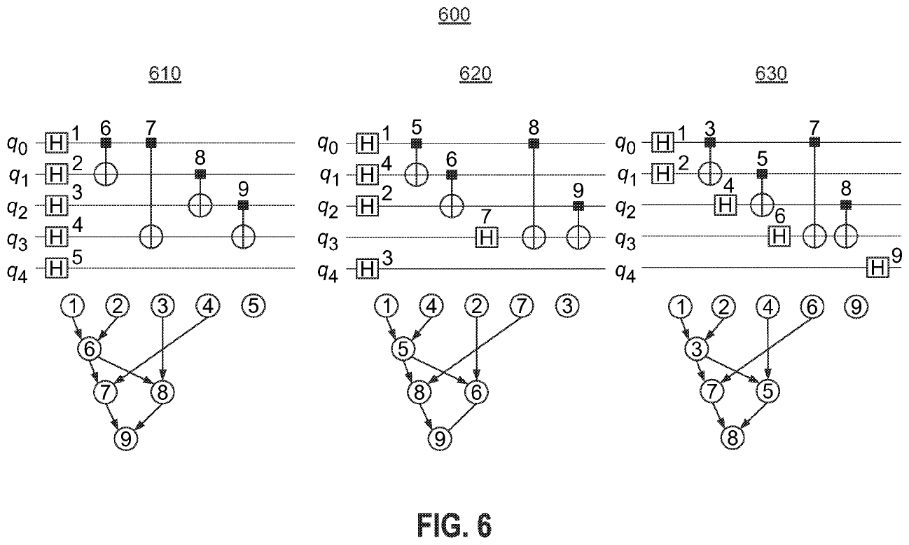

For baseline QCS, GPU memory 130 typically has a lower capacity than the CPU memory 120, which can cause a statistically larger number of chunks to be allocated to the CPU memory 120 when the number of qubits in the quantum circuit to be simulated is large. Accordingly, the CPU may perform state amplitude update without the benefits of the GPU acceleration (e.g., parallelism of GPUs). Further, when the number of qubits increases (e.g., to be greater than approximately 30 qubits), the CPU operates for greater durations of simulation time than the GPU, such that a majority (e.g., most) of the computation of the baseline QCS is performed by the CPU while the GPU is idle based on the static state chunk allocation described herein. Attempts have been made to use dynamic allocation of chunks as an optimization to improve baseline QCS performance (referred to hereinafter as “naïve QCS”), but such attempts have failed to result in improvements based on causing increased data movement between the CPU memory 120 and the GPU memory 130. In some cases, such naïve QCS techniques have reduced QCS performance (e.g., as shown with respect to FIG. 6). Accordingly, systems and methods for using GPUs and end-to-end optimizations may be used to improve QCS performance, particularly for quantum circuits including large numbers of qubits, e.g., 10, 30, 50, 100, or even more qubits.

### Optimized Quantum Circuit Simulation (QCS)

As described herein, systems and methods for using GPUs to optimize QCS performance are contemplated. The systems and methods may include one or more optimizations configured to improve the QCS performance (e.g., including QCS efficiency and/or scalability) relative to conventional QCS techniques. The systems and methods may enable production of realistic quantum circuit simulators that simulate complex quantum phenomena of quantum many-particular systems, which can enable real-world quantum algorithm development, the advancement of practical quantum compiler, programming interface, runtime management and quantum device architecture. As described herein, the optimizations may include (1) proactive state amplitude transfer to fully utilize the bi-directional data transfer bandwidth between CPU and GPU; before copying state amplitudes to GPU, (2) dynamic redundancy elimination that prunes zero state amplitudes to avoid unnecessary data movements; (3) a compiler-assisted, dependency-aware quantum gate reordering to enlarge the potential of pruning for the number of zero amplitudes; and (4) a GPU-supported, lossless amplitude compression to reduce the data transfer caused by non-zero state amplitudes with minimal runtime overheads.

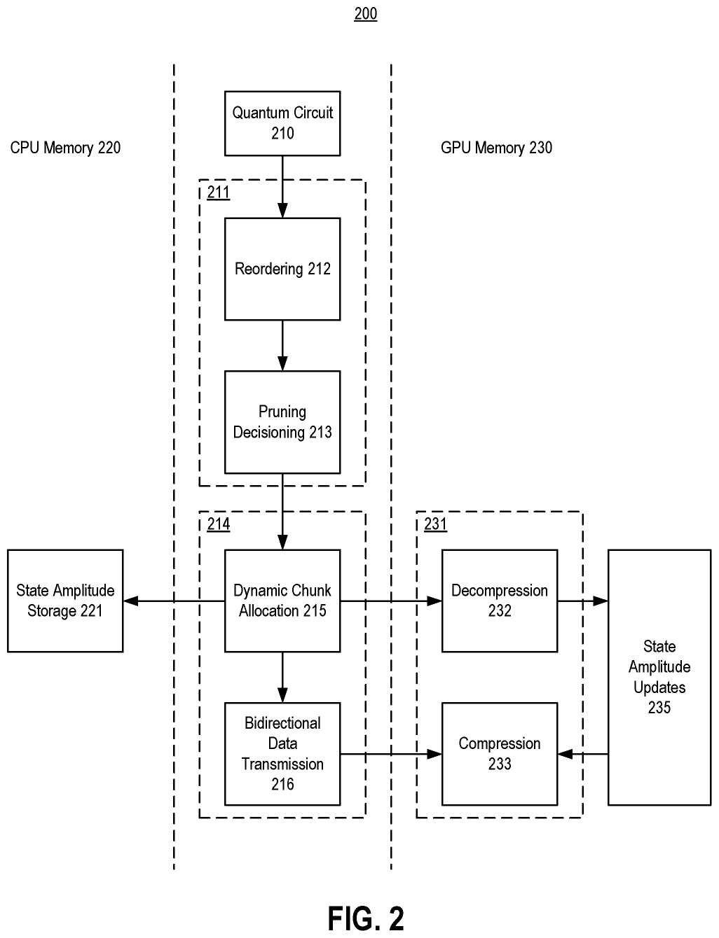

FIG. 2 shows a diagram of an exemplary QCS framework 200 for a quantum circuit simulator. A server computing device (or any other suitable computing device) as described herein may implement the QCS framework 200 to perform QCS for a quantum circuit 210 provided as an input to the QCS framework 200. As a part simulation of the quantum circuit 210 based on the QCS framework 200, data transfer (e.g., sending and/or receiving of data) may occur between CPU memory 220 corresponding to one or more CPUs and GPU memory 230 corresponding to one or more GPUs.

In some embodiments, the QCS framework 200 may include optimizations 214 for proactive state amplitude transfer. The optimizations 214 may include dynamic chunk allocation 215 and bidirectional data transmission 216 between the CPU memory 220 and the GPU memory 230, which operate with state amplitude storage 221 on the CPU memory 220 and state amplitude updates 235 on the GPU memory 230 as shown in FIG. 2. In some cases, the optimizations 214 may enable improved GPU utilization (e.g., relative to the baseline QCS described herein). For baseline QCS, a reason for poor GPU utilization can be the sequential state amplitude transfer between CPU (e.g., CPU memory 120) and GPU (e.g., GPU memory 130). Specifically, when the GPU completes updating state amplitudes of all local chunks, the chunks may be first copied back to CPU memory before the CPU can transfer a subsequent batch of un-updated chunks to the GPU and GPU memory. Such a restriction can be reasonable in the scenarios when particular chunks are involved in consecutive updates, since the chunks being copied from the GPU's memory cannot be overwritten during the copying, such that data movements are synchronized to avoid data conflicts. If the subsequent chunks from the CPU are not copied to the same locations on the GPU memory where current chunks are stored, such data conflict may not exist. As a result, a quantum circuit simulator may be able to transfer the chunks simultaneously from the CPU memory to the GPU memory and from the GPU memory to the CPU memory.

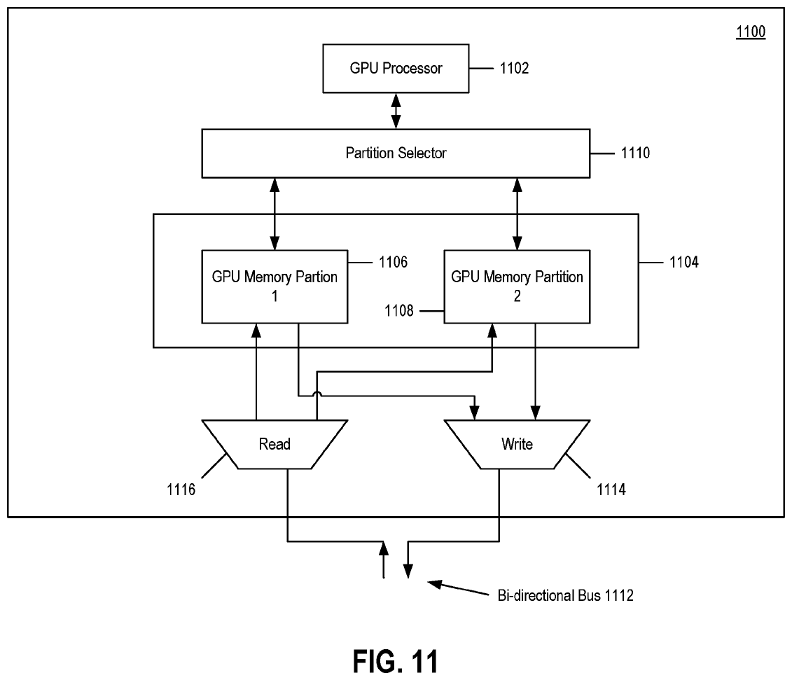

In some embodiments, the optimizations 214 of the QCS framework 200 may use one or more Compute Unified Device Architecture (CUDA) streams to enable concurrent (e.g., simultaneous) and bidirectional chunk copy between the CPU memory 220 and the GPU memory 230. Such dynamic chunk allocation 215 and bidirectional data transmission 216 may enable improved (e.g., full) utilization of available bandwidth between the CPU memory 220 and the GPU memory 230. In some cases, the QCS framework 200 may use two CUDA streams and may partition the GPU memory 230 into two parts (e.g., halves). The use of two CUDA streams and partitioning of the GPU memory 230 into two halves may be to avoid data conflict for data transferred between the CPU memory 220 and the GPU memory 230. A first CUDA stream of the two CUDA streams may be configured as responsible for a first half partition of the GPU memory 230, such that the first CUDA stream operates as a buffer storing the chunks that the GPU corresponding to the GPU memory 230 is currently updating. A second CUDA stream of the two CUDA streams may be configured as responsible for a second half partition of the GPU memory 230, such that the second CUDA stream operates as a buffer for “prefetching” the subsequent chunks for the GPU to update. The first half partition and the second half partition of the GPU memory 230 may operate as “circular buffers” to provide the GPU (and the GPU memory 230) with required chunks to update the state vector. In general, in a bidirectional exchange, one state vector is received by the GPU (from the CPU) for processing, and another, updated state vector is provided by the GPU to the CPU. In general, a state vector, whether the initial one or a previously updated one is updated via the application of a gate, i.e., a logical operation or transform, to the state vector. In some cases, the first CUDA stream and the second CUDA stream may execute concurrently and/or overlap. An implementation of a GPU circular buffer is described below with reference to FIG. 11. Performance improvements corresponding to the implementation of the optimizations 214 in the QCS framework are described further with respect to FIG. 6.

In some embodiments, the QCS framework 200 may include optimizations 211 for pruning zero state amplitudes and reordering to delay qubit involvement. The optimizations 211 may include pruning decisioning 213 corresponding to pruning zero state amplitudes and reordering 212 corresponding to reordering to delay qubit involvement and enlarge pruning potential. In some cases, the optimizations 211 may enable a reduction of moving zero amplitudes between the CPU memory 220 and the GPU memory 230. While the optimizations 214 can improve bandwidth utilization for the CPU memory 220 and the GPU memory 230, the total number of amplitudes that are transferred between each respective memory may remain the same. To reduce the data movement between the CPU memory 220 and the GPU memory 230 during QCS, one or more zero state amplitudes may be pruned (e.g., removed) according to the QCS framework 200 before transferring chunks between the respective memories (e.g., according to the optimizations 214).

For a quantum circuit including n-qubits, the initial states are often configured as |0 [symbol] ^{⊗n} in the general (e.g., theoretical) QCS, which indicates that all qubits have zero probability of being measured as |1 [symbol] . Accordingly, all state amplitudes are zeros, except for a₀_{₁}₀_{₂}_{. . . 0}_{ₙ} which is 1. As the state of a particular qubit is unchanged until an operation is applied to it, its state remains |0 [symbol] until the operation is applied to the qubit. As an example, if a particular qubit qₖ is |0 [symbol] , all of the state amplitudes a_{× . . . ×1}_{ₖ}_{× . . . ×} are zeros because qₖ has zero probability to be measured as |1). Generally, if m of n-qubits are not involved in the application of a gate, i.e., in the application of a logical operation

$${a}_{\times {0}_{{k}_{1}} \times {0}_{{k}_{2}} … \times {0}_{{k}_{m}} \times \times }$$

can be non-zero values, while remaining state amplitudes will be guaranteed to be zeros (e.g., such that 2ⁿ−2^{n-m} state amplitudes are zero values. If only one qubit is not involved, half of the state amplitudes are zeros.

For particular quantum circuits described with respect to Table 1, pruning of zero state amplitudes to reduce data movement between the CPU memory 220 and the GPU memory 230 may enable performance improvements. Performance improvements may be larger for quantum circuits involving a large number of operations before all qubits are involved in operations. As an example, an iqp circuit performs 132 operations out of a total of 146 operations before all qubits are involved, such that 90.41% of operations occur before all qubits are involved. Generally, for an operation involving m states, if all the states are zero, the m states remain zeros after applying any operation. Because the m states remain zeros, the zero state amplitude are not required to be transferred from the CPU to the GPU (e.g., due to their values remaining the same). Accordingly, a quantum circuit simulator may reduce data movement between CPU memory and GPU memory by pruning (e.g., removing) zero state amplitudes.

In some embodiments, of the optimizations 211, pruning decisioning 213 of the QCS framework 200 may use one or more bits in a binary string as indicators (e.g., flags) to indicate whether a particular qubit has been involved after a set of gate operations. Pruning decisioning 213 may operate according to a pruning algorithm. The pruning algorithm may use a binary string (referred to as an “involvement string” or “involvement”) to indicate whether a particular qubit was involved in a set of gate operations as described herein. The number of bits included in the involvement string may be based on a number of qubits (e.g., equivalent to a number of qubits). As an example, for n number of qubits, there may be n number of bits in the involvement string, such that the involvement string has 2ⁿ possible states. All bits in the involvement string may initially be configured to 0. When a particular qubit qₖ is involved in a gate operation, the kth bit in the involvement string may be configured from 0 to 1. As described herein, a state vector may be partitioned into one or more chunks. An index (referred to as “iChunk”) of a particular chunk may determine whether a particular chunk is transferred between the CPU memory 220 and the GPU memory 230. To compare (e.g., iteratively compare) iChunk to the indicator bits included in the involvement string, the pruning algorithm may determine a left shifted version of iChunk (referred to as “iChunk′”), such that iChunk′ aligns with the bits included the involvement string. The pruning algorithm may iteratively compare iChunk′ to the bits in the involvement string. When iChunk′ is larger than the involvement string, at least one bit of iChunk′ is 1 and the corresponding indicator bit in the involvement string is 0, such that the corresponding qubit (e.g., as indexed by the indicator bit in the involvement string) has not been involved by any gate operation. When iChunk′ is larger than the involvement string, the pruning algorithm may skip the remaining chunks and may end the iterative comparison. When iChunk′ is smaller than or equal to the involvement string, the redundancy within a chunk may be determined by a binary “AND” (also referred to as “&”) operation applied to iChunk′ and the involvement string. For a particular qubit whose corresponding bit in iChunk′ is 1, when the qubit has previously been involved in gate operation(s), the qubit's corresponding bit in the involvement string may be 1. Accordingly, for all qubits that are equivalent to 1 in iChunk′, based on each of the respective qubits already having been involved in previous gate operations, the binary AND operation applied to iChunk′ and the involvement string may output the value of iChunk′ for the respective qubits. Otherwise, each of the state amplitudes in the respective chunk may be zeros, which may enable the pruning algorithm to prune the chunk and prevent the chunk from potentially being transferred between the CPU memory 220 and the GPU memory 230.

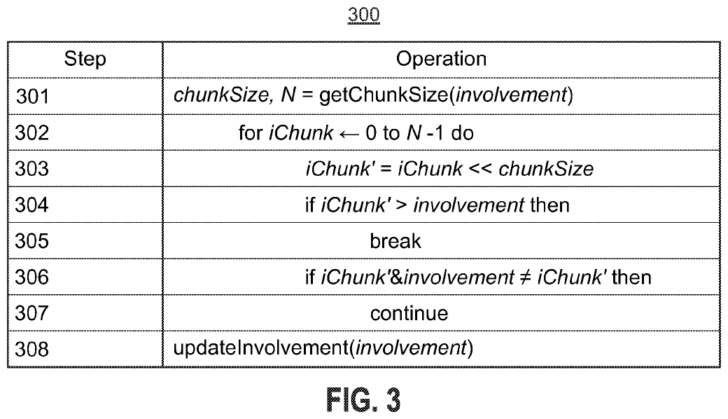

FIG. 3 shows operations of an exemplary pruning algorithm 300. The pruning algorithm 300 may include one or more operations, such that the operations corresponding to steps 301 to 308 as shown in FIG. 3. As shown in FIG. 3, “N” refers to a total number of chunks in the CPU memory 220, “involvement” refers to the involvement string, and “chunkSize” refers to a value determined based on locating the least significant non-zero bit of involvement. The function “getChunkSize( )” may receive involvement as an input and may provide chunkSize and N as outputs.

With respect to the chunkSize as described in FIG. 3, the chunkSize may be dynamically determined (e.g., based on the involvement string) rather than being configured as a statically fixed value. As described above, the pruning algorithm may select the value of chunkSize by determining the least (e.g., least significant) non-zero bit of the involvement string (i.e. involvement). Such an operation may increase efficiency of the pruning algorithm, particularly at the beginning of the QCS where many state amplitudes are zeros. As an example, for an 8-qubit circuit and when the involvement string is initially 00000011, the chunkSize may be dynamically set to 2 based on the least non-zero bit of the involvement string being 2 and the pruning algorithm described in FIG. 3, which has fewer zeros within a chunk compared to a larger chunk. The bits of the involvement string may be updated according to the qubits involved in each operation as described by step 308 in FIG. 3.

In some embodiments, of the optimizations 211, reordering 212 of the QCS framework 200 may include compiler-assisted, dependency-aware quantum operation (e.g., step) reordering. Such reordering may enlarge the potential of pruning decisioning 213 by increasing a number of state amplitudes that are zeros. The reordering 212 may delay the involvement of qubits in gate operations as a part of QCS. When applying a gate, the QCS framework 200 may apply the gate that incurs a minimum number of additional qubits to be involved with the qubits that have previously been involved with previous gate operations. Gates that are applied on different qubits in a quantum circuit can be executed independently in any order, such that the execution sequences of the independent gates do not affect a result of the QCS. Accordingly, reordering 213 as a part of the QCS framework 200 may use a directed acrylic graph (DAG) to represent the gate dependency within a quantum circuit. Based on the DAG, the QCS framework 200 may reorder the independent gates (e.g., the gates that may be executed independently in any order) such that the QCS involves the minimum number of new qubits when simulating each gate. One or more heuristics strategies may be used to reorder the independent gates including, for example, (1) greedy reordering; and (2) forward-looking reordering.

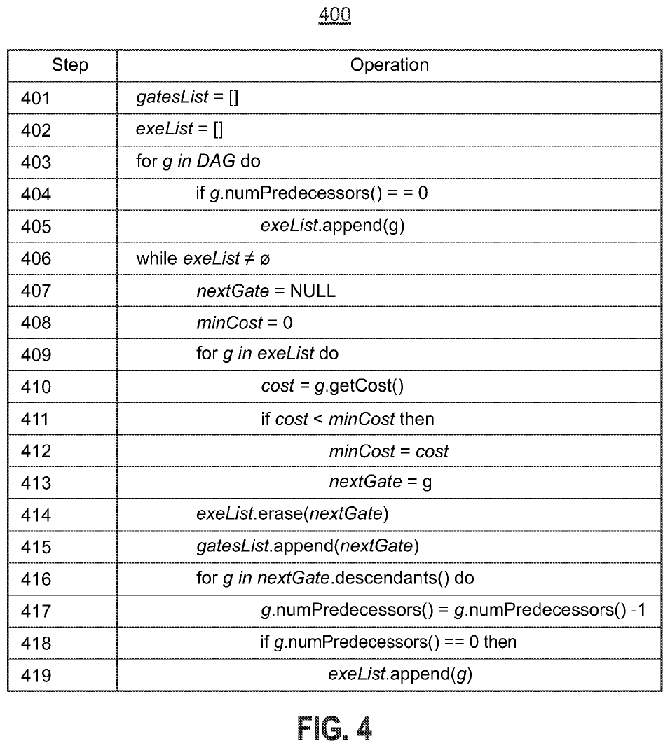

In some embodiments, with respect to greedy reordering, the QCS framework 200 may traverse a DAG in a topological order and may select the gate (corresponding to a respective node in the DAG) that introduces the minimum number of new qubits to the list of updated qubits. A method (e.g., performed by the QCS framework 200) to execute greedy reordering may operate according to a greedy reordering algorithm. FIG. 4 shows operations of an exemplary greedy reordering algorithm 400. The greedy reordering algorithm 400 may include one or more operations, such that the operations corresponding to steps 401 to 419 as shown in FIG. 4. As shown in FIG. 4, “DAG” refers to a DAG representing circuit dependencies, “g” refers to gates from DAG, “exeList” refers to a list of gates that are executable, “cost” refers to a counter for a priority of gates in exeList, and “gatesList” refers to a reordered list of gates determined after reordering operations executed according to the greedy reordering algorithm. DAG may be an input of the greedy reordering algorithm and gatesList may be an output of the greedy reordering algorithm.

As described above in FIG. 4, gates without predecessors in the DAG can be executed at the first steps and can be added into exeList (e.g., as described in steps 401-405 of FIG. 4). The QCS framework 200 may traverse the gates included in exeList and may identify and select the gate included in exeList that introduces the minimum number of newly involved qubits (e.g., as described in steps 406-413 of FIG. 4). Based on identifying and selecting the gate that introduces the minimum number of newly involved qubits, the QCS framework 200 may remove the selected gate from exeList and may append the selected gate to the list of reordered gates (e.g., gatesList as described herein). Based on appending the selected gate to the list of the reordered gates (e.g., as described In steps 414 and 415 of FIG. 4), the QCS framework 200 may traverse the descendants of the appended gate and if a particular descendant does not have any predecessors other than the appended gate, the QCS framework may add the particular descendant to exeList (e.g., as described by steps 416-419 of FIG. 4). Iteratively traversing the gates included in exeList and selecting the gate included in exeList that introduces the minimum number of newly involved qubits may execute until exeList is empty (e.g., as described by steps 406-419 of FIG. 4). In some cases, while the greedy reordering algorithm may improve upon baseline operation with reordering 213, the greedy reordering algorithm may not optimally reorder the gate sequence (e.g., as described with respect to FIG. 6). For such cases, the QCS framework 200 may apply a forward-looking reordering technique.

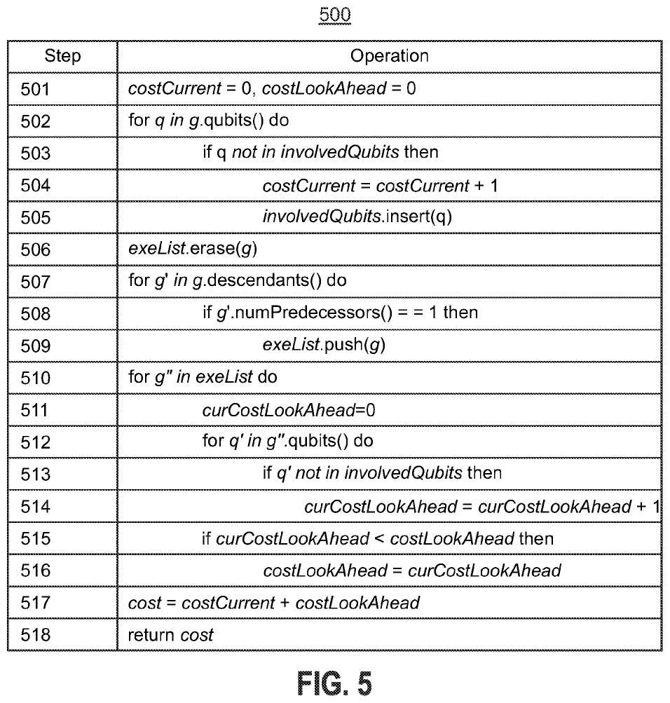

In some embodiments, with respect to forward-looking reordering, the QCS framework 200 may look ahead of all equal-priority gate candidates before making a reordering decision. A method (e.g., performed by the QCS framework 200) to execute forward-looking reordering may operate according to a forward-looking reordering algorithm. FIG. 5 shows operations of an exemplary forward-looking reordering algorithm 500. The forward-looking reordering algorithm 500 may include one or more operations, such as the operations corresponding to steps 501 to 518 as shown in FIG. 5. As shown in FIG. 5, “exeList” refers to a list of gates that are executable, g refers to gates from exeList, “involvedQubits” refers to a set of qubits that have been acted on (e.g., by gate operations), and “cost” refers to potentially involved qubits after executing g. In some cases, exeList, g, and involvedQubits may be inputs to the forward-looking reordering algorithm and cost may be an output of the forward-looking reordering algorithm.

With respect to FIG. 5 and the forward-looking reordering algorithm, the QCS framework 200 may use the cost counter to determine the priority of the gates in the exeList. For the forward-looking reordering algorithm, the cost of selecting a gate in exeList may be based on one or more components. The one or more components may include costCurrent and costLookAhead (e.g., as initialized in step 501 of FIG. 5), where cost as described with respect to FIG. 4 may be analogous and/or equivalent to costCurrent as described with respect to FIG. 5. Based on the forward-looking reordering algorithm, the QCS framework 200 may determine additional qubits that may be acted upon by executing a current gate (e.g., as described by steps 501-509 of FIG. 5). Based on determining the additional qubits, the QCS framework 200 may traverse the current exeList and may determine (e.g., compute) the cost of selecting a gate that involves the least additional qubits.

FIG. 6 shows a diagram 600 of exemplary reordering of quantum operations. FIG. 6 shows exemplary operation reordering for a graph state (gs) quantum circuit with 5 quantum bits (referred as a “gs_5” quantum circuit). The gs_5 circuit may include H gate and CNOT gate operations. Operation reordering is shown in FIG. 6 with respect to an original execution order 610, a greedy reordering execution order 620, and a forward-looking reordering execution order 630 for the gs_5 circuit. The qubits q₀, q₁, q₂, q₃, and q₄ shown in FIG. 6 are representative of the 5 qubits corresponding to the gs_5 circuit. The numerals (e.g., numerals 1-9) shown for orders 610, 620, and 630 may describe orders of steps for applying gates of the gs_5 circuit to 16 respective qubits. As an example, the numeral “2” in the greedy reordering execution order 620 indicates that an H gate applied to qubit q₂ is the second step of the 9 steps.

With respect to the original execution order 610 for the gs_5 circuit (e.g., performed using baseline QCS), the first 5 gates are H gates applied to an individual qubit. Based on the application of each of the 5 H gates, all of the available qubits q₀-q₄ are involved. A subsequent step (e.g., step 6 for the order 610) may apply a CNOT gate (referred to as “CNOT₆” based on being the sixth step) to qubits q₀ and q₁. All the state amplitudes for the qubits are likely to be non-zero because the qubits are involved by the H gates. Accordingly, applying the CNOT₆ gate can require updating all the non-zero amplitudes in the state vector, leading to moving and traversing the entire state vector on the GPU. However, the CNOT₆ gate can be executed before at least some of the H gates without violating the circuit semantics. Such gate reordering (e.g., as described with respect to greedy and forward-looking reordering) may enable additional zero state amplitudes (and fewer data movements between CPU memory 220 and GPU memory 230) when simulating the CNOT₆ gate. Any reordering of operations may be required to obey the gate dependencies. As an example, with respect to FIG. 6, CNOT₆ and CNOT₇ may not be reordered due to the dependency on q₀.

In some embodiments, as described herein, the QCS framework 200 may execute reordering 213 using a greedy reordering algorithm (e.g., as described with respect to FIG. 4). The greedy reordering execution order 620 in FIG. 6 shows reordering of the original execution order 610 for the gs_5 circuit according to the greedy reordering algorithm. Initially, to reorder operations of the gs_5 circuit according to the greedy reordering algorithm described with respect to FIG. 4, the exeList may be [g₁, g₂, g₃, g₄, g₅], such that exeList is representative of steps 1-5 (e.g., H gate steps) of the original execution order 610. Since each of these 5 gates of exeList involves one new qubit, the greedy reordering algorithm may randomly select 1 gate from exeList to start simulation. As an example, g₁ may be selected as the starting gate. Based on traversing each of the descendants of g₁, the greedy reordering algorithm may determine that no new gates can be added into exeList. Accordingly, the exeList may become [g₂, g₃, g₄, g₅]. For the next 3 steps, the greedy reordering algorithm may randomly select g₃, g₅ and g₂ because no new gates can be executed and all gates in exeList may have equal priority. The exeList may become [g₄, g₆] and the involvedQubits may be [q₀, q₁, q₂, q₄]. Therefore, g₄ involves one new qubit (q₃) as shown with respect to the original execution order 610, whereas g₆ will not introduce any new qubits based on operating on q₀ and q₁ that are already in the involved list. Accordingly, the greedy reordering algorithm may select g₄ to execute at step 7 in the order 620, as g₄ involves the least new qubits. Executing such steps according to the greedy reordering algorithm may result in the greedy reordering execution order 620 as shown in FIG. 6. As a comparison of the orders 610 and 620, the number of involved qubits at each step for the greedy reordering execution order 620 may respectively be 1, 2, 3, 4, 4, 4, 5, 5, and 5 qubits for the 9 consecutive steps shown in the order 620, while the number of involved qubits at each step for the original execution order 610 may respectively be 1, 2, 3, 4, 5, 5, 5, 5, and 5 qubits for the 9 consecutive steps shown in the order 610, such that the order 620 delays involving the final (e.g., fifth) qubit by two steps. But, as described herein in some cases, the greedy reordering algorithm may not select the optimized ordering of steps, as selection of g₄ and g₆ in the second and third steps would improve performance compared to the selection of g₃ and g₅ in the second and third steps as shown in the order 620. Accordingly, the QCS framework may reorder the order 610 using the forward-looking reordering algorithm to determine the forward-looking reordering execution order 630.

In some embodiments, as described herein, the QCS framework 200 may execute reordering 213 using a forward-looking reordering algorithm (e.g., as described with respect to FIG. 5). The forward-looking reordering execution order 630 in FIG. 6 shows reordering of the original execution order 610 for the gs_5 circuit according to the forward-looking reordering algorithm. Initially, to reorder operations of the gs_5 circuit according to the forward-looking reordering algorithm described with respect to FIG. 5, the exeList may be [g₁, g₂, g₃, g₄, g₅]. As an example, for the computation of costLookAhead, g₁ may have already been executed, such that costCurrent is 1 and involvedQubits becomes [q₀] (e.g., as described by steps 502-506 in FIG. 5). Because no descendants of g₁ may be executed, the exeList may become [g₂, g₃, g₄, g₅].

In some embodiments, the QCS framework 200 may traverse the exeList (e.g., [g₁, g₂, g₃, g₄, g₅]) according to the forward-looking reordering algorithm, such that for each gate in exeList, the QCS framework 200 determines (e.g., computes) the cost of selecting the gate by counting the new involved qubits and selecting the least cost as costLookAhead (e.g., as described by steps 510-516 in FIG. 5). Executing any gate in exeList may then involve at least one qubit, such that costLookAhead can be determined to be 1. Similarly, all gates at the first step may have equal priority. Based on an assumption that g₁ is selected, exeList may become [g₂, g₃, g₄, g₅]. While each of the gates of exeList may have equal costCurrent, g₂ may have the least costLookAhead. g₂ may have the least costLookAhead based on looking ahead from executed g₂ and determining that that g₆ introduces no new qubits, while looking ahead from the other executed qubits of exeList would result in introducing new qubits. Executing steps according to the forward-looking reordering algorithm may result in the forward-looking execution order 630 as shown in FIG. 6. The number of involved qubits at each step for the forward-looking execution order 630 may respectively be 1, 2, 2, 3, 3, 4, 4, 4, and 5 qubits for the 9 consecutive steps shown in the order 630. Accordingly, compared to the greedy reordering execution order 620, the forward-looking execution order 630 further delays the final (e.g., fifth) qubit involvement by two steps with respect to the exemplary gs_5 circuit.

With respect to the QCS framework 200, the optimizations 211 for pruning zero state amplitudes (e.g., pruning decisioning 213) and reordering to delay qubit involvement (e.g., reordering 212) as described herein may not negatively affect results of a particular QCS and may not introduce error to quantum circuits. Such optimizations 211 may not introduce negative effects based on the partitioning of a quantum state vector into groups and updating each group in parallel as described herein with respect to the optimizations 214. As an example, a group of amplitudes may be a 1×n vector and a quantum gate may be an n×n matrix. Thus, the actual computation of the QCS framework 200 can involve multiple parallel 1×n vectors to n×n matrix multiplications. If a 1×n vector contains all zeros, the vector will remain unchanged after being multiplied with any matrix and can be pruned safely, as the all-zero 1×n vectors may remain on the CPU memory 220 without being transferred to the GPU memory 230. The reordering may not affect the QCS results based on the reordering 212 adhering to dependencies among gates.

In some embodiments, the QCS framework 200 may include optimizations 231 for reducing moving non-zero amplitudes between the CPU memory 220 and the GPU memory 230. The optimizations 231 may include decompression 232 and compression 233, which may be used to enable (and/or enhance the performance of) state amplitude updates 235 on the GPU memory 230. While pruning decisioning 213 as described with respect to the optimizations 211 can enable removal of zero state amplitudes, non-zero state amplitudes can cause data movement overheads that negatively impact QCS performance (e.g., particularly for a quantum circuit that has a small pruning potential). To reduce the data movement corresponding to the non-zero state amplitudes, the QCS framework 200 may use the optimizations 231 for GPU-supported efficient lossless data compression techniques. The decompression 232 and compression 233 used by the optimizations 231 may make use of similar amplitude values among non-zero state amplitudes within a state vector to reduce data movement between the CPU memory 220 and the GPU memory 230.

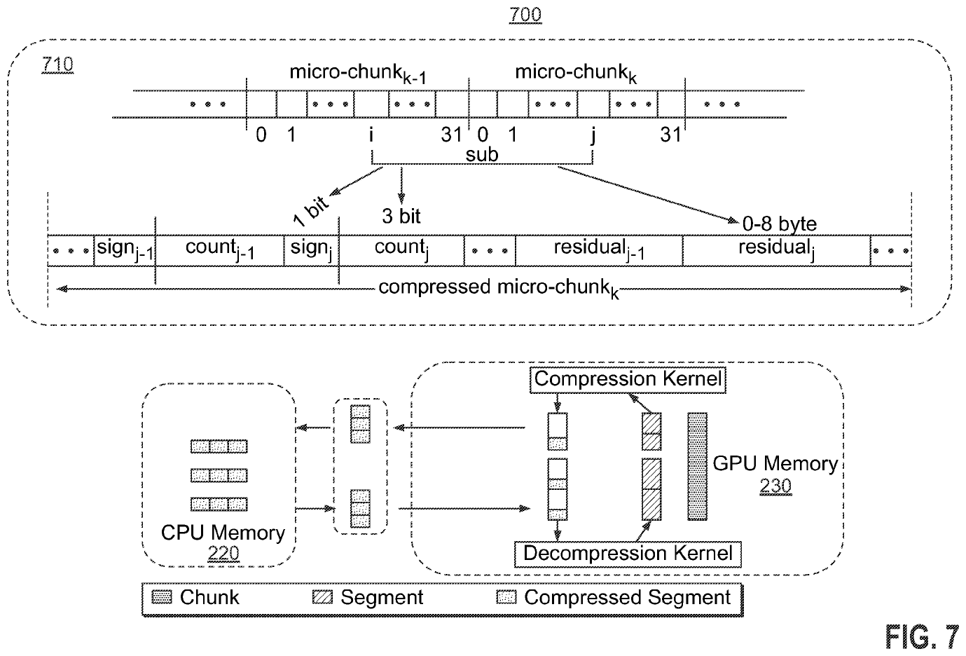

FIG. 7 shows a diagram 700 of exemplary decompression and compression of state amplitude vectors. The QCS framework 200 may execute the decompression and compression as shown and described with respect to FIG. 7, such that the CPU (and CPU memory 220) may store compressed state vectors and transfer the compressed state vector to the GPU, while the GPU (and GPU memory 230) may decompress, update, and compress the state vectors. As shown in FIG. 7, the “Compression Kernel” may correspond to the compression module 233 of FIG. 2 and the “Decompression Kernel” may correspond to the decompression module 232 of FIG. 2. To decompress and compress state vector(s) and their corresponding state amplitude(s), the optimizations 231 may use a GFC algorithm, where the GFC algorithm may be a double-precision floating-point compression algorithm. Some non-limiting examples of a GFC algorithm include those described by O'Neil et al. in “Floating-Point Data Compression at 75 Gb/s on a GPU” (GPGPU-4 (2011)).

Block 710 as shown in FIG. 7 shows exemplary compression of state amplitudes of one or more state vectors, where groups (e.g., chunks as shown in FIG. 7) of state amplitudes are segmented into “segments”. Each segment may be compressed and/or decompressed by a single warp. In some cases, multiple warps may compress multiple segments independently and concurrently. The QCS framework 200 may execute the GFC algorithm as shown in the block 710 using GPU kernels to perform parallel compression. Such parallel compression techniques may reduce compression and/or decompression overheads.

In some embodiments, the number of segments (e.g., segments per chunk) may be configured and/or otherwise selected to correspond to (e.g., match) the GPU parallelism (e.g., parallel execution capabilities of the GPU). By configuring the number of segments to correspond to the GPU parallelism, the GPU may have optimized utilization of the GPU and GPU memory 230. In some cases, to compress and/or decompress a single segment, a segment may be partitioned into one or more “micro-chunks”. The micro-chunks shown in the block 710 may correspond to segments of the state vectors stored by the GPU memory 230. Each micro-chunk may be of an equal size (e.g., 32 amplitudes) and may correspond to (e.g., match) the warp size. Each warp may iteratively compute residuals between consecutive micro-chunks within a segment and may encode the residuals into compressed formats.

In some embodiments, the GPU and the GPU memory 230 of the QCS framework 200 may execute the compression shown in block 710 (and decompression). The GPU may execute compression after updating a particular chunk of a state vector that includes the one or more segments and the one or more corresponding micro-chunks. The GPU may execute compression before transferring the one or more compressed segments micro-chunks to the CPU and corresponding CPU memory 220. After compression, the GPU may transfer the compressed segments (e.g., in place of the original chunks) to the CPU memory 220 as shown in FIG. 7. The CPU memory 220 may store compressed segments and/or decompressed segments (e.g., if the decompressed micro-chunks have yet to be transferred and/or copied to the GPU for updating and compression). Based on a request from the GPU, the CPU may transfer (e.g., copy) stored, compressed segments to the GPU and GPU memory 230.

In some embodiments, as an example, each microchunk may include 32 state amplitudes (e.g., numbered 0-31 as shown in FIG. 7). Each warp of the GPU (and GPU memory 230) may iteratively compress and/or decompress a group of one or more micro-chunks. As an example, thread; (for the interval of 0≤j≤31) of a particular warp may be responsible for subtracting data double; in a current micro-chunkₖ and corresponding data double, in a previous micro-chunkₖ₋₁ to determine the residual value. The warp may encode leading zeros of the residual into a prefix (e.g., a 4-bit prefix corresponding to signⱼ and count; as shown in FIG. 7), where 1 bit is used to record the sign (e.g., as signⱼ) and 3 bits are used to count the bytes of the leading zeros (e.g., as countⱼ). Other threads in the particular warp may execute the same steps on different data (e.g., a different segment) and may communicate through shared memory on the GPU memory 230 to determine (e.g., compute) the size of the compressed micro-chunks.

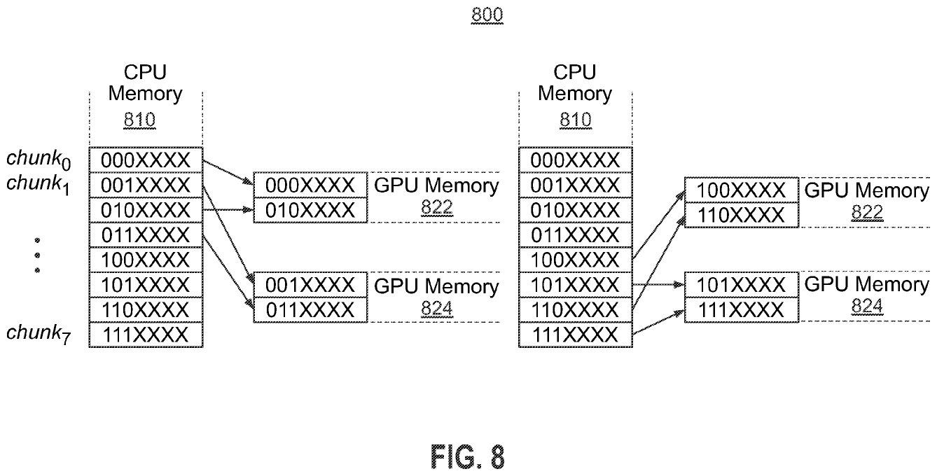

In some embodiments, the QCS framework 200 described with respect to FIG. 2 may be applied to multi-GPU computing systems. FIG. 8 shows operation of the QCS framework 200 for QCS in a multi-GPU application. For a multi-GPU application, the QCS framework 200 may assign all state amplitudes to CPU memory 810. As shown in FIG. 8, chunk₀ to chunk₇ may be stored by the CPU memory. The QCS framework 200 may partition the chunks of the state vector into one or more groups, where the one or more groups may be assigned to respective GPU memory(ies). For example, the QCS framework 200 may partition the chunks of the state vector into one or more groups, where the one or more groups may be assigned to a GPU memory 822 and a GPU memory 824 of respective first and second GPUs. As shown in FIG. 8, the QCS framework 200 may partition the chunks into four groups and may assign each of the four groups of chunks to the GPU memories 822 and 824. Chunks may be assigned to GPUs in a sequential and/or random order. As shown in FIG. 8, chunks chunk₀ to chunk₇ may be assigned in a “round-robin” order based on the number of chunks to be assigned and the number of GPU memories corresponding to a respective CPU memory 810. Based on assigning the chunks to the GPU memories 822 and 824, the QCS framework 200 may execute QCS as described with respect to FIG. 2. After completion of computing, the chunks assigned to each GPU memory (e.g., GPU memory 822 and GPU memory 824) may be copied back to the CPU memory 810. As an example, the chunks chunk₀, chunk₂, chunk₄, and chunk₆ may be copied from the GPU memory 822 to the CPU memory 810 and the chunks chunk₁, chunk₃, chunks, and chunk₇ may be copied from the GPU memory 824 to the CPU memory 810 at the completion of the computation according to the QCS framework 200.

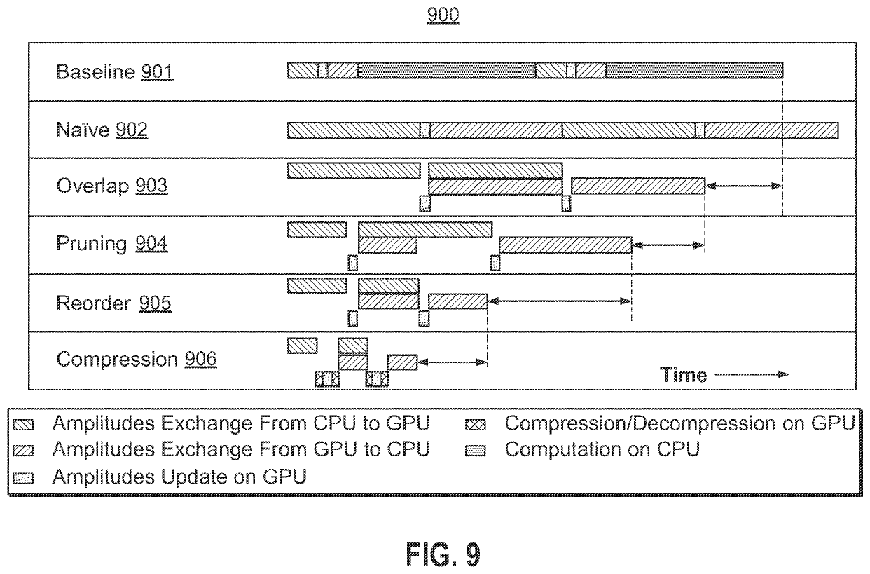

In some embodiments, the optimizations the QCS framework 200 may enable performance improvements for QCS relative to the baseline and the naïve QCS as described herein. Performance improvements may results from implementing any combination of the optimizations 211, 214, and 231 described with respect to the QCS framework 200. FIG. 9 shows a diagram 900 of exemplary performance of a QCS framework 200 for a quantum circuit simulator. The diagram 900 shows QCS performance improvement for implementing optimizations of the QCS framework 200 relative to the baseline QCS as described above. Each simulation shown in the diagram 900 shows simulation time for QCS of the same exemplary quantum circuit, such as the quantum circuit 210. Baseline QCS 901 may refer to baseline QCS as described herein. Naïve QCS 902 may refer to naïve QCS as described herein. The diagram 900 shows simulation time for baseline QCS 901, which may have the highest runtime for QCS of the exemplary quantum circuit relative to the other QCSs. In some cases, the simulation time for naïve QCS 902 (e.g., performed using dynamic chunk allocation) may have the similar or greater runtime than the simulation time for baseline QCS 901. As shown in FIG. 9, naïve QCS 902 of the exemplary quantum circuit (e.g., quantum circuit 210) may have a greater runtime than the baseline QCS 901. Overlap QCS 903 may correspond to implementing the optimizations 214 of dynamic chunk allocation 215 and bidirectional data transmission 216 during QCS of the exemplary quantum circuit. As shown in FIG. 9, the simulation time for overlap QCS 903 may be improved (e.g., reduced) relative to baseline QCS 901. Pruning QCS 904 may correspond to implementing the optimizations 214 and pruning decisioning 213 of the optimizations 211 during QCS of the exemplary quantum circuit. As shown in FIG. 9, the simulation time for pruning QCS 904 may be improved (e.g., reduced) relative to overlap QCS 903. Reorder QCS 905 may correspond to implementing the optimizations 211 and the optimizations 214 during QCS of the exemplary quantum circuit, including the reordering 212 as described herein. As shown in FIG. 9, the simulation time for reorder QCS 905 may be improved (e.g., reduced) relative to pruning QCS 904. Compression QCS 906 may correspond to implementing the optimizations 211, the optimizations 214, and the optimizations 231 during QCS of the exemplary quantum circuit, including the decompression 232 and the compression 233 as described herein. As shown in FIG. 9, the simulation time for compression QCS 906 may be improved (e.g., reduced) relative to reorder QCS 905.

### Further Description of Some Embodiments

FIG. 10 is a block diagram of an example computer system 1000 that may be used in implementing the technology described in this document. General-purpose computers, network appliances, mobile devices, or other electronic systems may also include at least portions of the system 1000. The system 1000 includes a processor 1010, a memory 1020, a storage device 1030, and an input/output device 1040. Each of the components 1010, 1020, 1030, and 1040 may be interconnected, for example, using a system bus 1050. The processor 1010 is capable of processing instructions for execution within the system 1000. In some implementations, the processor 1010 is a single-threaded processor. In some implementations, the processor 1010 is a multi-threaded processor. The processor 1010 is capable of processing instructions stored in the memory 1020 or on the storage device 1030.

The memory 1020 stores information within the system 1000. In some implementations, the memory 1020 is a non-transitory computer-readable medium. In some implementations, the memory 1020 is a volatile memory unit. In some implementations, the memory 1020 is a non-volatile memory unit.

The storage device 1030 is capable of providing mass storage for the system 1000. In some implementations, the storage device 1030 is a non-transitory computer-readable medium. In various different implementations, the storage device 1030 may include, for example, a hard disk device, an optical disk device, a solid-date drive, a flash drive, or some other large capacity storage device. For example, the storage device may store long-term data (e.g., database data, file system data, etc.). The input/output device 1040 provides input/output operations for the system 1000. In some implementations, the input/output device 1040 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1060. In some examples, mobile computing devices, mobile communication devices, and other devices may be used.

Referring to FIG. 1, a graphics processing unit (GPU) 1100 (or a vector processor in general) implementing a circular buffer includes a GPU/vector processor 1102. Typically, a GPU processor is a vector processor. The memory 1104 of the GPU 1100 is divided into two partitions: Partition 1 1106 and Partition 2, 1108. The GPU processor 1102 can selectively read from and write to the memory partitions 1106, 1108 via a partition selector 1110. In a typical operation, the partition selector 1110 may select partition 1 1106 (or partition 2 1108), read state vectors from the selected partition, update the read state vectors by applying gate(s) thereto, and write back the updated state vectors to the selected partition. Thereafter, the updated state vectors may be transferred to a bidirectional bus 1112 via a partition bus write selector 1114. The bidirectional bus 1112 may be in communication with a CPU (not shown).

Simultaneously, i.e., while the updated state vectors are being written to the bidirectional bus 1112, one or more chunks of state vectors may be received on the bidirectional bus 1112 from the CPU and, via the partition bus read selector 1116, those state vectors may be written to the partition not selected by the GPU processor 1110, i.e., partition 2 1108 (or partition 1 1106). The partition bus write selector 1114 and the partition bus read selector 1116 collectively may be called a bus selector. Subsequently, for the next iteration, the partition selector 1110 selects the previously unselected partition, i.e., partition 2 1108 (or partition 1 1106). The GPU processor may now read state vectors from the newly selected partition, update the state vectors, and write back the updated state vectors to the newly selected partition.

Thereafter, these updated vectors may be written to the bidirectional bus 1112 via the partition bus write selector 1114, and simultaneously, new chunk(s) of state vectors may be received from the CPU into partition 1 1106 via the partition bus read selector 1116. During the subsequent next iteration, the partition selector 1110 selects again the initially selected partition, i.e., partition 1 1106 (or partition 2 1108), and the process described continues. In general, the GPU processor 1102 is able to toggle between reading state vectors from and writing updated state vectors to the partitions 1 and 2 1106, 1108. Thus, from the perspective of the processor 1102, the GPU memory 1104 includes two circularly connected partitions 1106, 1108.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1030 may be implemented in a distributed way over a network, for example as a server farm or a set of widely distributed servers, or may be implemented in a single computing device.

Although an example processing system has been described in FIG. 10, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A method for efficient simulation of a quantum computer, the method comprising:
identifying from a plurality of state amplitude vector chunks, a first chunk and a second chunk, wherein any state amplitude vector in the second chunk is updatable independently of an update to any state amplitude vector in the first chunk; and
simultaneously transferring: (i) from a first memory partition of a vector processor to a host processor an updated first chunk, and (ii) from the host processor to a second memory partition of the vector processor the second chunk.

2. The method of claim 1, further comprising:
identifying a qubit having a zero probability of being in a quantum state 1;
identifying one or more chunks from the plurality of state amplitude vector chunks corresponding to the identified qubit; and
preventing transferring of the identified one or more chunks from the host processor to the vector processor.

3. The method of claim 1, further comprising:
scheduling application of one or more gates by the vector processor to the first chunk based on an order of involvement of a plurality of qubits, wherein the scheduling comprises greedy reordering or forward-looking reordering.

4. The method of claim 1, further comprising:
compressing the updated first chunk prior to transferring the updated first chunk from the vector processor to the host processor.

5. The method of claim 4, wherein the compressing comprises segmenting the updated first chunk into a plurality of segments, each segment being assigned to a respective warp in the vector processor.

6. The method of claim 1, further comprising:
receiving from the host processor to these first or the second memory partition of the vector processor a compressed chunk;
decompressing the compressed chunk by the vector processor; and
processing the decompressed chunk by the vector processor.

7. A system for efficient simulation of a quantum computer, the system comprising:
one or more processing devices programmed to perform operations comprising:
identifying from a plurality of state amplitude vector chunks, a first chunk and a second chunk, wherein any state amplitude vector in the second chunk is updatable independently of an update to any state amplitude vector in the first chunk; and
simultaneously transferring: (i) from a first memory partition of a vector processor to a host processor an updated first chunk, and (ii) from the host processor to a second memory partition of the vector processor the second chunk.

8. The system of claim 7, wherein the operations further comprise:
identifying a qubit having a zero probability of being in a quantum state 1;
identifying one or more chunks from the plurality of state amplitude vector chunks corresponding to the identified qubit; and
preventing transferring of the identified one or more chunks from the host processor to the vector processor.

9. The system of claim 7, wherein the operations further comprise:
scheduling application of one or more gates by the vector processor to the first chunk based on an order of involvement of a plurality of qubits, wherein the scheduling comprises greedy reordering or forward-looking reordering.

10. The system of claim 7, wherein the operations further comprise:
compressing the updated first chunk prior to transferring the updated first chunk from the vector processor to the host processor.

11. The system of claim 10, wherein the compressing comprises segmenting the updated first chunk into a plurality of segments, each segment being assigned to a respective warp in the vector processor.

12. The system of claim 7, wherein the operations further comprise:
receiving from the host processor to these first or the second memory partition of the vector processor a compressed chunk;
decompressing the compressed chunk by the vector processor; and
processing the decompressed chunk by the vector processor.

13. A vector processing system comprising:
a vector processor;
a memory comprising a first partition and a second partition;
a partition selector configured to provide selectively, read-write access to the vector processor to the first and second partitions; and
a bus selector configured to couple selectively the first or the second partition to a bidirectional bus for bus read operations and to couple selectively, the second or the first partition to the bidirectional bus for bus write operations.
